(19) United States
(12) Patent Application Publication
(10) Pub. No.: US 2008/0024728 A1
(43) Pub. Date: Jan. 31, 2008

(54) Imager Illumination System and Corresponding Projector

(76) Inventor: Pascal Benoit, Liffre (FR)

Correspondence Address: THOMSON LICENSING LLC, Two Independence Way, Suite 200, PRINCETON, NJ, 08540, US

(21) Appl. No.: 11/630,006

(22) PCT Filed: Jun. 28, 2005
(86) PCT No.: PCT/EP05/53032

§ 371 Date: Dec. 18, 2006

(30) Foreign Application Priority Data
Jul. 2, 2004 (FR) 04/51427

(51) Int. Cl. G03B 21/28

(52) U.S. Cl. 353/20

(57) ABSTRACT

The invention relates to an illumination system intended to illuminate an imager, which comprises a plurality of illumination sources generating source beams having two separate polarizations. To optimize the effectiveness of the source beams, the source beams illuminate a grid polarizer, one polarization passes through the polarizing surface of the polarizer, before being reflected by a mirror and passing again through the polarizing surface; the second polarization is reflected by the polarizing surface, the two polarizations thus being spatially separate; next, half-wavelength phase shift means phase-shift only one of the two polarizations. The invention also relates to a projector comprising the illumination system, the imager and a projection objective.

### 1. FIELD OF THE INVENTION

The invention relates to the field of image projection. More precisely, the invention relates to a system that emits a polarized illumination beam particularly well suited to an imager.

### 2. PRIOR ART

According to the prior art, projection with an imager of the transmissive LCOS or liquid-crystal type employs an illumination system with uniform polarized light. To obtain effective projection, the illumination system polarizes an illumination beam coming from a source of unpolarized light and converts the undesirable polarizations. To do this, conventional systems (fly's-eye or rod integrator) use a PBS (polarizing beam splitter) grating.

According to another known technique of the prior art, as illustrated in patent document U.S. Pat. No. 6,190,013 from the company Minolta®, the illumination system comprises a single PBS half-prism (multilayer polarizing splitter) with a first fly's-eye lens array plate. A first polarization is reflected then transmitted to a second lens array. A second polarization passes through the half-prism and is reflected off a mirror placed behind the splitting surface of the half-prism. The second polarization passes again through the half-prism and is returned via an array of λ/2 (half-wave) plates located on the second lens array plate.

These techniques have the drawback of a large PBS prism size. Furthermore, there is an angular limitation in the contrast of the PBS. Moreover, there is a loss of flux from P-polarized rays on return to the PBS (called skew rays).

### 3. SUMMARY OF THE INVENTION

The object of the invention is to alleviate these drawbacks of the prior art.

More particularly, the objective of the invention is to provide polarized illumination with a system of great luminous efficiency.

For this purpose, the invention proposes an illumination system intended to illuminate an imager, the system comprising a plurality of illumination sources each generating illumination beams, called source beams, having separate first and second polarizations. According to the invention, the system is noteworthy in that it further comprises a grid polarizer illuminated by the source beams, a mirror, and half-wavelength phase shift means; the first polarization of each of said source beams passes through the polarizing surface of the polarizer before being reflected by the mirror and passing through the polarizing surface of the polarizer again; the second polarization of each of the source beams is reflected by the polarizing surface of the polarizer; and only one of the first and second polarizations passing through the phase shift means after having passed through or after being reflected off the polarizing surface, the first and second polarizations of the source beams being spatially separated.

Thus, after the phase shift means, a single polarization is present for illuminating the imager.

According to a preferred feature, the system is noteworthy in that it comprises a light pipe and a main light source, the illumination sources being obtained by transmission, through the light pipe, of an illumination beam generated by the main light source.

According to one particular feature, the light pipe is a rod integrator.

According to another feature, the system is noteworthy in that it comprises a plurality of light-emitting diodes, each of the diodes being associated with one of the illumination sources.

According to a preferred feature, the reflecting surface of the mirror is parallel to the polarizing surface of the polarizer.

Advantageously, the grid polarizer comprises a transparent substrate, one face of which forms the polarizing surface of the polarizer and the other face of which forms the reflecting surface of the mirror.

Preferably, the illumination system comprises a first group of lenses that includes at least one focusing lens located between the illumination sources and the polarizer, the phase shift means lying in a plane placed between the two focal planes in which the illumination sources are focused by the first group, each of the two focal planes corresponding either to the first polarization or to the second polarization.

According to one advantageous feature, the illumination system comprises a second group of lenses and the imager placed in a first focal plane of the second group of lenses, the second focal plane of the second group of lenses being placed between the two focal planes in which the illumination sources are focused by the first group.

Preferably, the phase shift means comprise a substrate, one of the faces of which includes half-wavelength phase shift bands.

The invention also relates to a projector comprising:
the illumination system;
an imager illuminated by the illumination system; and
a projection objective.

### 4. LIST OF FIGURES

The invention will be better understood, and other features and advantages will become apparent, on reading the following description, which refers to the appended drawings in which:

FIG. 1 illustrates a back-projector employing an illumination system for an imager, according to one particular embodiment of the invention;

FIGS. 2 and 3 show the illumination system of FIG. 1;

FIGS. 4 and 5 show schematically illumination beams employed in the system of FIGS. 2 and 3;

FIG. 6 shows a polarizing splitter employed in the system of FIGS. 2 and 3;

FIG. 7 illustrates the distribution of the sources before the polarizing splitter shown in FIG. 6;

FIG. 8 illustrates the image of the sources after the polarizing splitter shown in FIG. 6; and

FIGS. 9 and 10 show alternative embodiments of the polarizer employed in the system of FIGS. 2 and 3.

### 5. DETAILED DESCRIPTION OF THE INVENTION

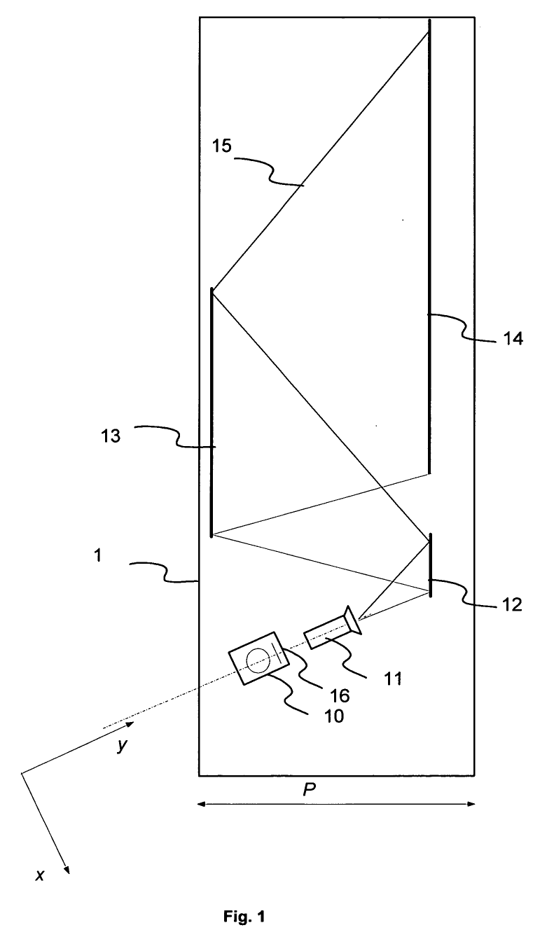

FIG. 1 illustrates a back-projector 1 employing an illumination system 10 for an imager 16, according to one particular embodiment of the invention.

The back-projector 1 comprises:
the illumination system 10 illuminating the imager 16;
a projection objective 11 transmitting an imaging beam 15 produced by the imager 16;
folding mirrors 12 and 13 off which the imaging beam 15 is reflected; and
a screen 14 onto which an image produced by the imaging beam 15 is projected.

According to the invention, the back-projector may be relatively narrow. However, owing to the small size of the illumination system 10 and the illumination beam being folded, the invention is particularly suitable for back-projectors of small thickness (for example a thickness of 6 or 9 inches). Of course, the invention also applies to wider back-projectors (for example with a single folding mirror) and to front projectors.

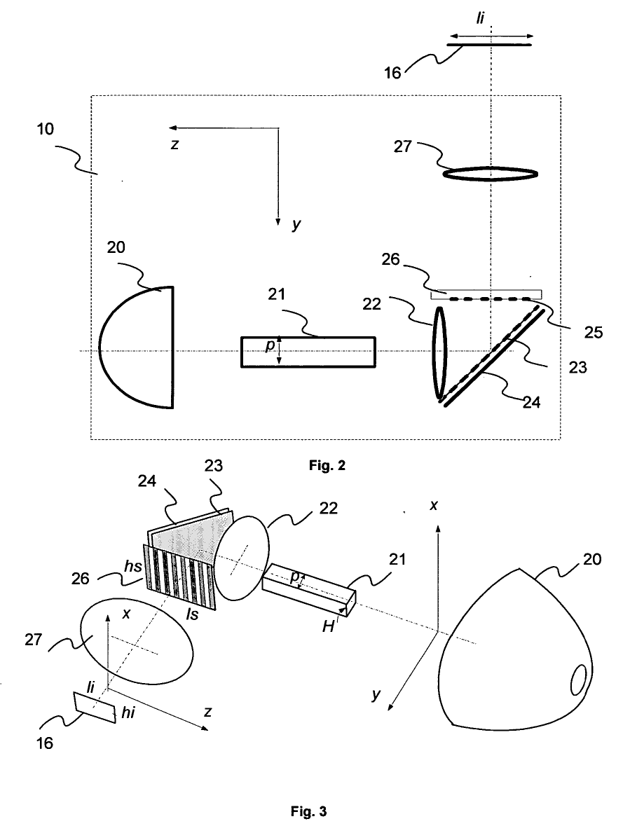

FIGS. 2 and 3 show the illumination system 1, in a side view and in perspective respectively, which illuminates an imager 16 of the transmissive LCD (liquid crystal display) type. The imager 16 has a width li and a height hi which depend on the aspect ratio of the image to be projected.

The illumination system 1 comprises:
a plurality of light sources producing unpolarized light (that is to say having at least two different polarizations), the sources being separated in a plane perpendicular to a propagation axis;
a second lens 22 (or a group of several lenses) of focal length F1;
a grid polarizer 23;
a mirror 24 located behind the grid polarizer 23;
half-wavelength phase shift means, for example in the form of λ/2 bands 25 placed on a transparent substrate 26 (for example made of glass), the bands 25 being, for example, obtained by lamination on the substrate 26; and
a second lens 27 (or a group of several lenses) of focal length F2.

The grid polarizer 23 is for example provided by the company MOXTEK®, one face corresponding to the polarizing surface and the other face being, for example, treated so as to be reflective.

The magnification of the lens 22 is equal to G1 (plane of the bands 25 relative to the entrance plane of the light pipe 21).

Preferably, the λ/2 bands 25 are achromatic over the visible spectral range: the retardation varies with the wavelength so that the difference between the ordinary and extraordinary indices respectively is equal to one half-wavelength divided by the thickness of the bands 25 over the visible spectral range.

According to a variant, the λ/2 bands 25 have a constant or substantially constant retardation over the visible spectral range. The λ/2 bands 25 phase-shift by a half-wavelength a precise frequency in the visible spectral range. Preferably, this frequency is the mid-frequency of the visible spectrum.

According to one particular embodiment of the invention, the plurality of light sources is generated using a lamp-type main light source 20 and a light pipe of height H, length L and depth p. The light sources are thus obtained by transmission through the light pipe of a source illumination beam produced by the main light source. The light pipe is, for example, a solid rod integrator or a hollow light pipe with reflecting walls.

The illumination system illuminates the imager 16 operating with a polarized illumination beam. Also, according to a variant of the invention, the imager is of the LCOS (liquid crystal on silicon) type associated with a polarizing splitter (grid polarizer or PBS) in order to redirect the imaging beam.

According to other variants, a polarizer is placed in the path of the polarized illumination beam before the imager so as to purify the polarization and enhance the contrast.

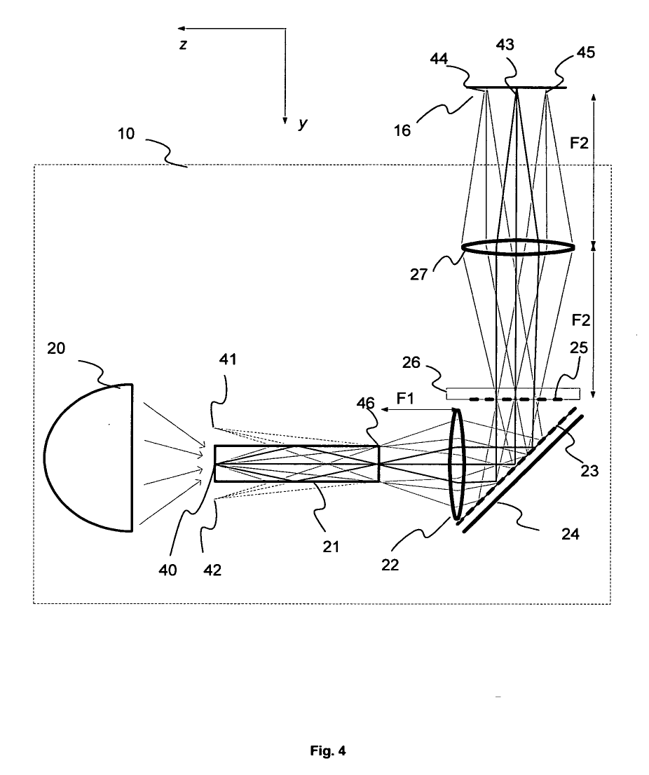

FIGS. 4 and 5 show schematically illumination beams employed in the system 10 according to vertical and horizontal polarizations respectively.

The lamp 20 illuminates the entrance of the light pipe 21 lying parallel to an axis z, its height and its depth being parallel to axes x and y respectively. On exiting the light pipe, several virtual sources are present, forming a matrix comprising several rows and several columns.

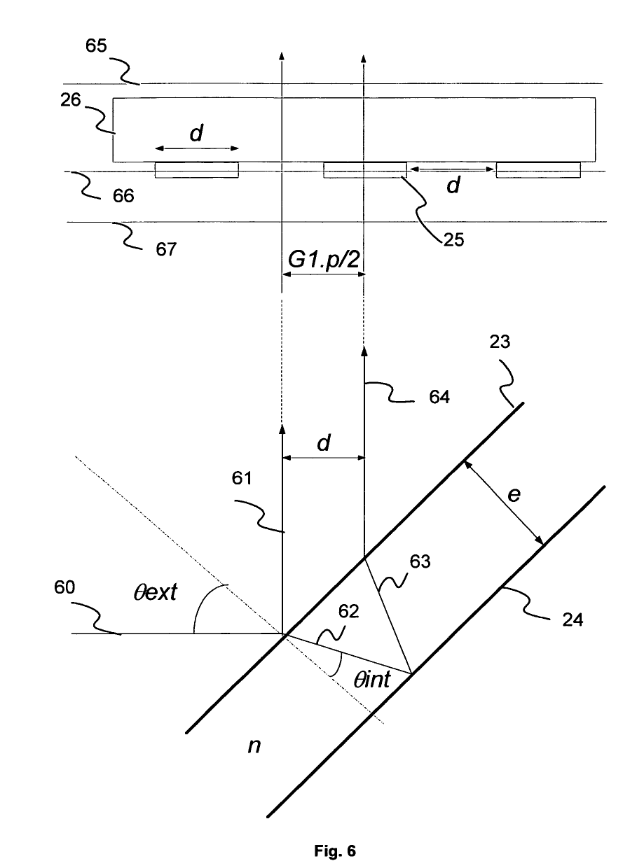

The first lens 22 images the entrance of the light pipe 21 in a plane close to the λ/2 bands 25 and the exit of the light pipe 21 at infinity (the distance between the lens 22 and the exit of the light pipe is equal to F1). Thus, several virtual sources corresponding to the sources present at the entrance of the guide 21 appear around the plane of the λ/2 bands 25. As an illustration, three sources 40 to 42 have been shown at the entrance of the light pipe 21 in FIGS. 4 and 5. As illustrated in FIG. 7, which shows the virtual sources placed at the entrance of the light pipe, these are separated by a distance h along the x axis and by a distance p along the y axis. Each of these virtual sources emits unpolarized light.

The number of sources depends on the aperture angle of the lamp, which defines the number of reflections of the beam in the light pipe 21. Preferably, the virtual sources form a matrix consisting of at least three rows and three columns.

The grid polarizer 23 located behind the first lens 22 in the path of the illumination beam splits the vertical polarization from the horizontal polarization. The grid polarizer is inclined, preferably at an angle of 45° to the z axis along which the illumination beam propagates. The grid of the polarizer is oriented along the x direction, perpendicular to the plane of propagation defined by the y and z axes. Thus, the vertical polarization of the illumination beam is reflected along the y direction. However, the horizontal polarization passes through the polarizing surface and the substrate of the polarizer 23.

The vertical polarization then passes through the substrate 26 in the regions outside the strips 25 and then passes through the second lens 27, which images the exit of the light pipe 21 on the imager 16.

After having passed a first time through the polarizer 23, the horizontal polarization is reflected by the mirror 24 parallel to the polarizing surface of the polarizer 23 and placed a distance e from this surface. Next, the horizontal polarization of the illumination beam passes through the polarizer 23 again and strikes the strips 25 which rotate the polarization, which therefore becomes vertical. On exiting the substrate 26, the illumination beam therefore comprises only the vertical polarization obtained by direct transmission of the vertical polarization exiting the light pipe 21 and by returning the horizontal polarization. Thus, the use of the illumination beam is optimized.

According to an alternative embodiment, the grid of the polarizer is oriented perpendicular to the x direction. It is then the horizontal polarization of the illumination beam that is reflected. In this embodiment, the vertical polarization passes through the polarizing surface. In this case, upon exiting the substrate 26, the illumination beam therefore comprises only the horizontal polarization (if the strips or bands 25 are positioned at the same location).

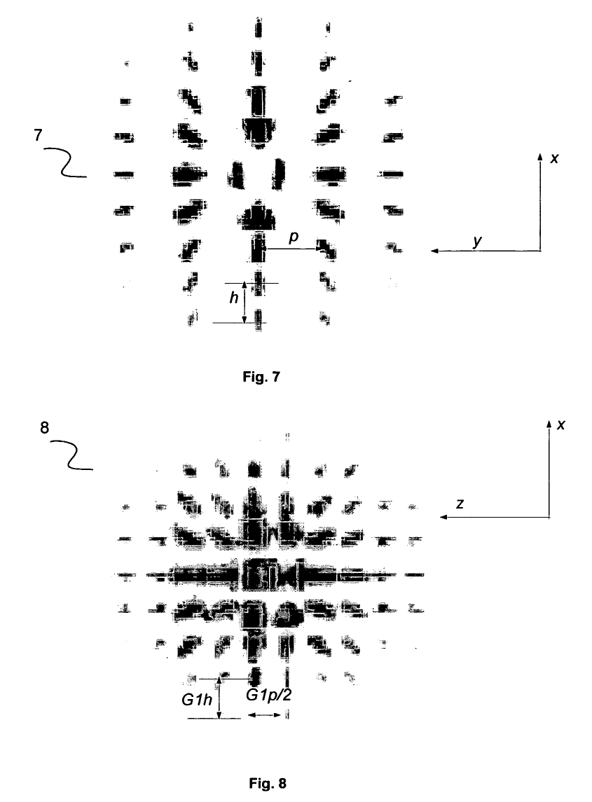

As illustrated in FIG. 8, the substrate is the glass plate 26 bearing the half-wave strips 25. It does not matter whether the substrate is placed before or after the bands 25 in the path of the illumination beam. Each of the columns is separated by a distance G1p/2, one column in two corresponding to that part of the illumination beam which is reflected by the polarizer 23 and the other columns corresponding to that part of the illumination beam which is reflected by the mirror 24. Preferably, the area of the bands 25 (or substrate 26) is such that it collects at least six columns of sources, the number of bands depending on the number of rows. Even more preferably, the area of the substrate 26 is such that it collects at least eight columns of sources. The area of the substrate is greater than the aperture of the objective through the lens 27.

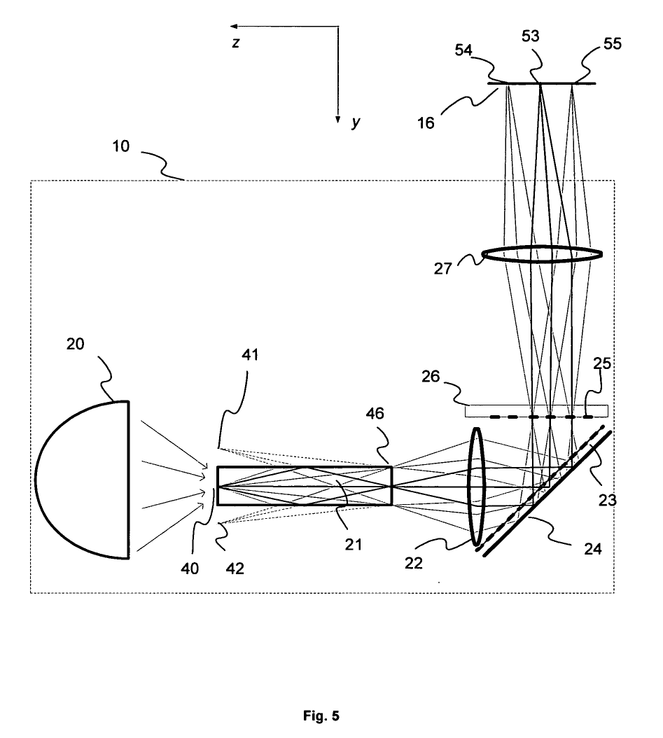

FIG. 6 illustrates in detail the path of a ray 60 of the illumination beam striking the polarizer 23.

The incident ray 60 makes an angle θext with the normal to the splitting surface of the polarizer 23. The incident ray 60 is partly reflected by the polarizing surface, forming a vertically polarized ray 61, and partly refracted, forming a horizontally polarized ray 62. The ray 62 is reflected by the mirror 24, forming a ray 63 which is itself refracted by the polarizing surface, forming a ray 64.

The polarizing surface of the polarizer 23 and the mirror 24 are separated by a material of optical index n and of thickness e. As indicated in FIG. 6, the rays 61 and 64 are separated by a distance d, which depends on the parameters n and e according to the equations:
n sin(θint)=sin(θext) and
d=2e tan (θint)cos(θext)=G1p/2.

The substrate 26 comprises λ/2 phase shift bands 25 parallel to the x axis, which change the polarization. Each of the bands is separated from an adjacent band by a distance d and itself has a width d. It is positioned so that the ray 61 passes through the substrate 26 without passing through the bands 25 and so that, in contrast, the ray 64 passes through the bands 25 so that its polarization is modified and then passes through the second lens 27, which images the exit of the light pipe 21 on the imager 16.

According to an alternative embodiment of the invention, the bands 25 are placed in the path of the polarization that is reflected by the polarizing surface of the polarizer 23, the polarization that passes through this surface not illuminating the bands 25.

Thus, depending on the orientation of the grid of the polarizer 23 and on the placement of the bands 25, the polarization of the illumination beam exiting the substrate 26 is either horizontal or vertical. The imager 16 must be oriented correctly according to the polarization of the illumination beam that illuminates it.

The virtual sources placed at the entrance of the light pipe 21 (especially sources 41 to 42) are focused, through the first lens 22, on two planes 65 and 67 that are slightly offset depending on the polarization of the rays striking the polarizer 23:
a first plane 65 corresponding to the focusing of the rays that are reflected by the polarizer 23; and
a second plane 67 corresponding to the focusing of the rays that pass through the polarizer 23.

The offset of the planes corresponds to the optical path difference between these rays, i.e. Δ, which satisfies the equation:
Δ=2ne/cos(θint)−2e tan(θint)/sin (θext)=2e/cos(θint)×(n−1/n).

Since preferably the optical distance between the polarizing surface 23 of the polarizer and the reflecting surface 24 is relatively small, the optical path difference between the two polarizations is itself relatively small, as is the offset between the focal planes 65 and 67. The λ/2 bands 25 are placed in a plane 66 lying between the focal planes 65 and 67. Preferably, the plane 66 is the mid-plane of the planes 65 and 67. Thus, the two polarizations are spatially well separated at the bands 25.

Moreover, the first lens 22 images the exit of the light pipe 21 at infinity (the distance between the lens 22 and the light pipe exit is equal to F1).

The distances separating the lens 27 and the plane of the bands 25 on the one hand, and the imager 16 on the other, are equal to the focal length F2. More precisely, the imager 16 lies in a first focal plane of the lens 27 while the second focal plane of the lens 27 lies between the focal planes 65 and 67 of the lens 22, and preferably in the mid-plane of the planes 65 and 67. In this way, the illumination on the imager is optimized.

Moreover, the angle θext is preferably between 30° and 60°. A wide range of values is possible depending on the various embodiments of the invention. In fact, the grid polarizer has the advantage of giving a contrast that is relatively insensitive to the angle of incidence. More preferably still, the angle θext is equal to 45°.

The geometry of the illumination system also allows the illumination beam to be folded, thereby reducing its overall size (especially within the context of use in a narrow back-projector or front projector). The value of θext may therefore advantageously be chosen according to the space constraints specific to the projector in question.

The dimension of the substrate 26 along the x axis is hs and along the y axis it is li. The dimensions of the substrate 26 are chosen according to the number of virtual sources illuminating it.

As an illustration, the parameters of the illumination system may be the following:
d=2.5 mm;
n=1.5 (glass);
e=3.3 mm;
and G1=0.55 for p=9 mm (with a light pipe 9 mm×5.06 mm in cross section).

The dimensions of the light pipe are generally set partly by the aspect ratio of the imager (for example 3/4 or 16/9), by the size of the focal spot of the lamp, in order to have good collection, and the dimensions of the imager, in order to have a magnification of around 2 (other magnifications are possible).

A light pipe of small cross section allows the system to work with a constant extent with large angles (typically between 15° and 25°).

The lamp 20 may also be relatively powerful since, unlike PBS polarizers, the grid polarizer 23 can withstand high luminous flux levels well.

Furthermore, such a polarizer also has the advantage of giving a largely wavelength-insensitive contrast.

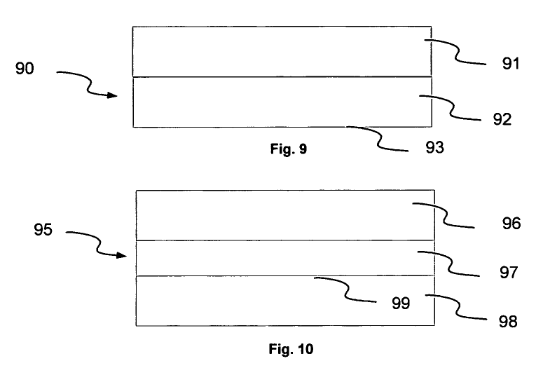

FIG. 9 illustrates a polarizer 90 that can be used, according to the invention, as a replacement for the polarizer 23 and the mirror 24.

The polarizer 90 comprises a grid polarizer 91, similar to the polarizer 23, and a substrate 92, for example made of glass covered with a reflecting surface 93 on one of its faces.

FIG. 10 illustrates a polarizer 95 that can also be used, according to the invention, as a replacement for the polarizer 23 and the mirror 24.

The polarizer 95 comprises a grid polarizer 96, similar to the polarizer 23, and a substrate 98, for example made of glass. The substrate 98 and the polarizer 96 are separated by a thin layer of air 97. The substrate 98 is covered with a reflecting surface 99 on one of its faces, which is preferably that common with the layer of air 97.

Of course, the invention is not limited to the embodiments described above.

The invention in particular relates to various types of projectors employing an illumination beam with polarized light, especially back-projectors or front projectors. Furthermore, these projectors may or may not include one or more flat or curved folding mirrors.

The illumination system is positioned or oriented in various ways relative to the imager, depending on different embodiments of the invention. According to a preferred embodiment, it may especially undergo a rotation of 180° along the axis of the imaging beam that illuminates the imager. In the context of projection onto a 4/3 or 16/9 screen, or more generally when one dimension is larger than the other, the sources are preferable doubled along the larger dimension. In other embodiments, the rotation is equal to ±90°. It may also be relatively far from the projection objective, the projection objective being matched to the overall geometry of the structure of the projector. The objective makes it possible in particular to focus an image produced by the imager on the screen, while limiting distortion. However, the projection objective is preferably as close as possible to the illumination system.

According to one embodiment of the invention (not shown), the plurality of light sources is obtained using a plurality of LEDs (light-emitting diodes), each of the LEDs corresponding to a light source. Preferably, each of the LEDs is associated with optical means for uniformly illuminating the imager. This may be a reflector or appropriate collimation or collection means.

1. An illumination system intended to illuminate an imager, said system comprising a plurality of illumination sources each generating illumination beams, called source beams, having separate first and second polarizations,
wherein the system further comprises a grid polarizer illuminated by said source beams, a mirror, and half-wavelength phase shift means;
said first polarization of each of said source beams passing through the polarizing surface of said polarizer before being reflected by said mirror and passing through the polarizing surface of said polarizer again;
said second polarization of each of said source beams being reflected by the polarizing surface of said polarizer; and
only one of said first and second polarizations passing through said phase shift means after having passed through said polarizing surface or after being reflected off said polarizing surface, said first and second polarizations of said source beams being spatially separated.

2. The system as claimed in claim 1, wherein it comprises a light pipe and a main light source, said illumination sources being obtained by transmission, through said light pipe, of an illumination beam generated by said main light source.

3. The system as claimed in claim 1, wherein said light pipe is a rod integrator.

4. The system as claimed in claim 1, wherein it comprises a plurality of light-emitting diodes, each of said diodes being associated with one of said illumination sources.

5. The system as claimed in claim 1, wherein the reflecting surface of said mirror (24, 99) is parallel to the polarizing surface of said polarizer.

6. The system as claimed in claim 1, wherein said grid polarizer comprises a transparent substrate, one face of which forms said polarizing surface of said polarizer and the other face (24)of which forms the reflecting surface of said mirror.

7. The system as claimed in claim 1, wherein it comprises a first group of lenses that includes at least one focusing lens located between said illumination sources and said polarizer, said phase shift means lying in a plane placed between the two focal planes in which said illumination sources are imaged by said first group, each of the two focal planes corresponding either to said first polarization or to said second polarization.

8. The system as claimed in claim 7, wherein it comprises a second group of lenses and said imager placed in a first focal plane of said second group of lenses, the second focal plane of said second group of lenses being placed between the two focal planes in which said illumination sources are focused by said first group.

9. The system as claimed in claim 1, wherein said phase shift means comprise a substrate, one of the faces of which includes half-wavelength phase shift bands.

10. A projector comprising:
an illumination system;
an imager illuminated by said illumination system; and
a projection objective,
wherein the illumination system comprising a plurality of illumination sources each generating illumination beams, called source beams, having separate first and second polarizations,
the illumination system further comprising a grid polarizer illuminated by said source beams, a mirror, and half-wavelength phase shift means;
said first polarization of each of said source beams passing through the polarizing surface of said polarizer before being reflected by said mirror and passing through the polarizing surface of said polarizer again;
said second polarization of each of said source beams being reflected by the polarizing surface of said polarizer; and
only one of said first and second polarizations passing through said phase shift means after having passed through said polarizing surface or after being reflected off said polarizing surface, said first and second polarizations of said source beams being spatially separated.
